(19) United States
(12) Patent Application Publication
(10) Pub. No.: US 2025/0157215 A1
(43) Pub. Date: May 15, 2025

(54) SELF-SUPERVISED COMPOSITIONAL FEATURE REPRESENTATION FOR VIDEO UNDERSTANDING

(71) Applicant: TOYOTA RESEARCH INSTITUTE, INC., Los Altos, CA (US)

(72) Inventors: Matthew Paul KOWAL, Ontario (CA); Pavel TOKMAKOV, West Hollywood, CA (US); Achal DAVE, San Francisco, CA (US); Rares Andrei AMBRUS, San Francisco, CA (US); Adrien David GAIDON, San Jose, CA (US)

(73) Assignees: TOYOTA RESEARCH INSTITUTE, INC., Los Altos, CA (US); TOYOTA JIDOSHA KABUSHIKI KAISHA, Aichi-Ken (JP)

(21) Appl. No.: 18/807,734

(22) Filed: Aug. 16, 2024

Related U.S. Application Data
(60) Provisional application No. 63/598,860, filed on Nov. 14, 2023.

(51) Int. Cl. G06V 20/40; G06V 10/762; G06V 10/774

(52) U.S. Cl. CPC G06V 20/41; G06V 10/762; G06V 10/774; G06V 20/46

(57) ABSTRACT

A method for discovering human-interpretable concepts from video-based transformer models is described. The method includes passing a set of videos through a video-based transformer model to select an intermediate video feature of each of the set of videos. The method also includes clustering the intermediate video feature of each of the set of videos to obtain corresponding tubelets to the selected intermediate video features of each of the set of videos. The method further includes clustering an entire dataset of tubelets to form concepts of the set of videos. The method also includes calculating an importance of each of the concepts of the set of videos to an output of the video-based transformer model.

### CROSS-REFERENCE TO RELATED APPLICATION

The present application claims the benefit of U.S. Provisional Patent Application No. 63/598,860, filed Nov. 14, 2023, and titled “DISCOVERING UNIVERSAL SPATIOTEMPORAL CONCEPTS IN VIDEO TRANSFORMERS,” the disclosure of which is expressly incorporated by reference herein in its entirety.

### BACKGROUND

### Field

Certain aspects of the present disclosure relate to machine learning and, more particularly, a system and method for self-supervised compositional feature representation for video understanding.

### Background

Autonomous agents rely on machine vision for sensing a surrounding environment by analyzing areas of interest in images of the surrounding environment. Although scientists have spent decades studying the human visual system, a solution for realizing equivalent machine vision remains elusive. Realizing equivalent machine vision is a goal for enabling truly autonomous agents. Machine vision is distinct from the field of digital image processing because of the desire to recover a three-dimensional (3D) structure of the world from images and using the 3D structure for fully understanding a scene. That is, machine vision strives to provide a high-level understanding of a surrounding environment, as performed by the human visual system, for enabling a variety of applications (e.g., robotics, vision-language understanding, autonomous vehicles, etc.).

A major challenge currently faced by the automotive industry is the development of video understanding modules for the noted variety of applications. Therefore, a technique for self-supervised compositional feature representation for video understanding, is desired.

### SUMMARY

A method for discovering human-interpretable concepts from video-based transformer models is described. The method includes passing a set of videos through a video-based transformer model to select an intermediate video feature of each of the set of videos. The method also includes clustering the intermediate video feature of each of the set of videos to obtain corresponding tubelets to the selected intermediate video features of each of the set of videos. The method further includes clustering an entire dataset of tubelets to form concepts of the set of videos. The method also includes calculating an importance of each of the concepts of the set of videos to an output of the video-based transformer model.

A non-transitory computer-readable medium having program code recorded thereon for discovering human-interpretable concepts from video-based transformer models is described. The program code is executed by a processor. The non-transitory computer-readable medium includes program code to pass a set of videos through a video-based transformer model to select an intermediate video feature of each of the set of videos. The non-transitory computer-readable medium also includes program code to cluster the intermediate video feature of each of the set of videos to obtain corresponding tubelets to the selected intermediate video features of each of the set of videos. The non-transitory computer-readable medium further includes program code to cluster an entire dataset of tubelets to form concepts of the set of videos. The non-transitory computer-readable medium also includes program code to calculate an importance of each of the concepts of the set of videos to an output of the video-based transformer model.

A system for discovering human-interpretable concepts from video-based transformer models is described. The system includes an intermediate feature selection module to pass a set of videos through a video-based transformer model to select an intermediate video feature of each of the set of videos. The system also includes a video tubelet generation module to cluster the intermediate video feature of each of the set of videos to obtain corresponding tubelets to the selected intermediate video features of each of the set of videos. The system further includes a video concept discovery module to cluster an entire dataset of tubelets to form concepts of the set of videos. The system also includes a video concept importance module to calculate an importance of each of the concepts of the set of videos to an output of the video-based transformer model.

This has outlined, broadly, the features and technical advantages of the present disclosure in order that the detailed description that follows may be better understood. Additional features and advantages of the present disclosure will be described below. It should be appreciated by those skilled in the art that the present disclosure may be readily utilized as a basis for modifying or designing other structures for conducting the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a system using a system-on-a-chip (SOC) for discovering human-interpretable concepts from a deep video transformer-based neural network, in accordance with aspects of the present disclosure.

FIG. 2 is a block diagram illustrating a software architecture that may modularize functions for discovering human-interpretable concepts from deep video transformer-based neural networks, according to various aspects of the present disclosure.

FIG. 3 is a diagram illustrating an example of a hardware implementation for a human-interpretable concept discovery system for understanding a video transformer-based neural network, according to aspects of the present disclosure.

FIG. 4 is a drawing illustrating an example of an ego vehicle in an environment, according to aspects of the present disclosure.

FIG. 5 is a combined drawing illustrating heatmap predictions of an occluded object tracking method, together with a sample of concepts discovered by a video transformer concept discovery (VTCD) algorithm, according to various aspects of the present disclosure.

FIG. 6 is a block diagram illustrating a video transformer concept discovery (VTCD) process for understanding video transformers through universal concept discovery, according to various aspects of the present disclosure.

FIG. 7 is a block diagram illustrating a visual representation of concept masking for a single concept, according to various aspects of the present disclosure.

FIG. 8 is a flowchart illustrating a method discovering human-interpretable concepts from a deep video transformer-based neural network, according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented, or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. Any aspect of the present disclosure disclosed may be embodied by one or more elements of a claim.

Although aspects are described herein, many variations and permutations of these aspects fall within the scope of the present disclosure. Although some benefits and advantages of the preferred aspects are mentioned, the scope of the present disclosure is not intended to be limited to benefits, uses, or objectives. Rather, aspects of the present disclosure are intended to be universally applicable to different technologies, system configurations, networks, and protocols, some of which are illustrated by way of example in the figures and in the following description of the preferred aspects. The detailed description and drawings are merely illustrative of the present disclosure, rather than limiting the scope of the present disclosure being defined by the appended claims and equivalents thereof.

The world is not understood in terms of pixels, surfaces, or entire scenes, but rather in terms of individual objects and their combinations, because objects are the key building blocks of perception. Object-centric representation enables tractable higher-level cognitive abilities such as casual reasoning, planning, etc., which are important for generalization and adaptation. Autonomous agents rely on machine vision for sensing a surrounding environment by analyzing areas of interest in images of the surrounding environment. Although scientists have spent decades studying the human visual system, a solution for realizing equivalent machine vision remains elusive.

Realizing equivalent machine vision is a goal for enabling truly autonomous agents. Machine vision is distinct from the field of digital image processing because of the desire to recover a three-dimensional (3D) structure of the world from images and using the 3D structure for fully understanding a scene. That is, machine vision strives to provide a high-level understanding of a surrounding environment, as performed by the human visual system, for enabling a variety of applications (e.g., robotics, vision-language understanding, autonomous vehicles, etc.).

A major challenge currently faced by the automotive industry is the development of video understanding modules for the noted variety of applications. Various tasks are still challenging for state-of-the-art neural networks. For example, tracking objects during transformations (e.g., cutting, folding) or occlusions often causes models to produce poor outputs. Unfortunately, the concepts used by successful or unsuccessful predictions are not well understood. Acquiring the capability to discover these concepts would allow for improved design of these models, datasets, and tasks to solve such problems. Furthermore, if these models are deployed, it is important for the automotive industry to determine failure modes and biases of the models, from both legal and application perspectives. Identifying failure modes improves processes internally as well as protecting against unwanted damages and legal challenges presented by real-world deployment of these systems.

A technique for compositional feature representation for video understanding may rely on concept discovery. As described, concept discovery is the task of identifying human-interpretable concepts in deep neural networks. While conventional algorithms may attempt to discover concepts in deep neural networks, these conventional algorithms do not work with (i) video understanding models or (ii) based on transformer architectures. Simply applying these conventional algorithms to video transformer models would fail due to the computational complexity of video tensors compared with images, and because the manipulation of tensors in a transformer produces significantly different effects on the output of the model than a convolutional neural network. To overcome these challenges, various aspects of the present disclosure leverage two unique clustering algorithms to efficiently compute concept vectors for a transformer and identify the specific features that enable the calculation of concept importance.

Various aspects of the present disclosure are directed to the problem of concept-based interpretability of transformer representations for videos. Concretely, some aspects of the present disclosure seek to explain the decision-making process of video transformers based on high-level, spatiotemporal concepts that are automatically discovered. Prior research on concept-based interpretability has concentrated solely on image-level tasks, such as image classification. Comparatively, video models deal with the added temporal dimension, increasing complexity and posing challenges in identifying dynamic concepts over time.

Various aspects of the present disclosure systematically address temporal dimension challenges by introducing a video transformer concept discovery (VTCD) process. Beneficially, the VTCD process provides an efficient approach for unsupervised identification of units of video transformer representations/concepts. Additionally, a noise-robust process is provided for ranking the importance of these units to the output of a model, allowing the analysis of the model's decision-making process. Performing this analysis jointly over a diverse set of supervised and self-supervised models provides several important discoveries about universal units of video representations. Additionally, this VTCD process can be used to improve model performance for fine-grained tasks.

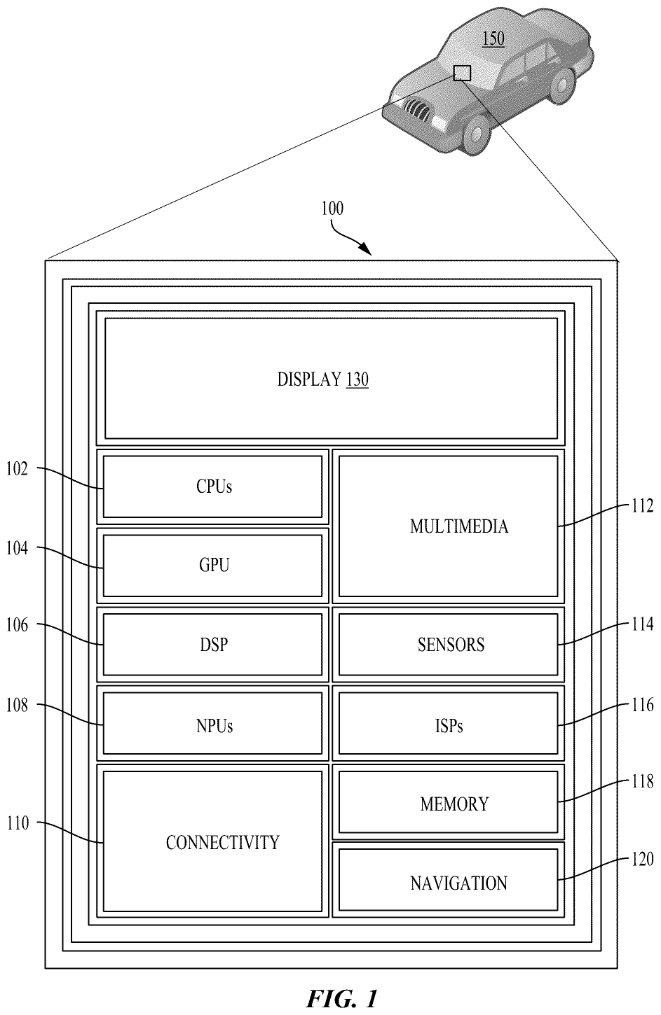

FIG. 1 illustrates an example implementation of the system and method for discovering human-interpretable concepts from a deep video transformer-based neural network using a system-on-a-chip (SOC) 100 of an ego vehicle 150. The SOC 100 may include a single processor or multi-core processors (e.g., a central processing unit (CPU) 102), in accordance with certain aspects of the present disclosure. Variables (e.g., neural signals and synaptic weights), system parameters associated with a computational device (e.g., neural network with weights), delays, frequency bin information, and task information may be stored in a memory block. The memory block may be associated with a neural processing unit (NPU) 108, a CPU 102, a graphics processing unit (GPU) 104, a digital signal processor (DSP) 106, a dedicated memory block 118, or may be distributed across multiple blocks. Instructions executed at a processor (e.g., CPU 102) may be loaded from a program memory associated with the CPU 102 or may be loaded from the dedicated memory block 118.

The SOC 100 may also include additional processing blocks configured to perform specific functions, such as the GPU 104, the DSP 106, and a connectivity block 110, which may include fourth generation long term evolution (4G LTE) connectivity, unlicensed Wi-Fi connectivity, USB connectivity, Bluetooth® connectivity, and the like. In addition, a multimedia processor 112 in combination with a display 130 may, for example, classify and categorize semantic keypoints of objects in an area of interest, according to the display 130 illustrating a view of a vehicle. In some aspects, the NPU 108 may be implemented in the CPU 102, DSP 106, and/or GPU 104. The SOC 100 may further include sensors 114, image signal processors (ISPs) 116, and/or navigation 120, which may, for instance, include a global positioning system (GPS).

The SOC 100 may be based on an Advanced Risk Machine (ARM) instruction set or the like. In another aspect of the present disclosure, the SOC 100 may be a server computer in communication with the ego vehicle 150. In this arrangement, the ego vehicle 150 may include a processor and other features of the SOC 100.

In this aspect of the present disclosure, instructions loaded into a processor (e.g., CPU 102) or the NPU 108 of the ego vehicle 150 may include code to perform representation learning for object discovery from unlabeled video frame sequences captured by the sensors 114 (e.g., a LIDAR sensor/camera). The instructions loaded into the NPU 108 may also include code to discover human-interpretable concepts from a deep video transformer-based neural network. The instructions loaded into the NPU 108 may also include code to pass a set of videos through a video-based transformer model to select an intermediate video feature of each of the set of videos.

Additionally, the instructions loaded into the NPU 108 may also include code to apply simple linear iterative clustering (SLIC) to each intermediate video feature of the set of videos to obtain corresponding tubelets to the selected intermediate video features of each of the set of videos. The instructions loaded into the NPU 108 may further include code to cluster the entire dataset of tubelets through convex non-negative matrix factorization to form concepts of the set of videos. The instructions loaded into the NPU 108 may also include code to calculate the concepts' importance by simultaneously removing a set of concepts from features of the vision-based transformer model and calculating a performance degradation from a baseline performance of the vision-based transformer model.

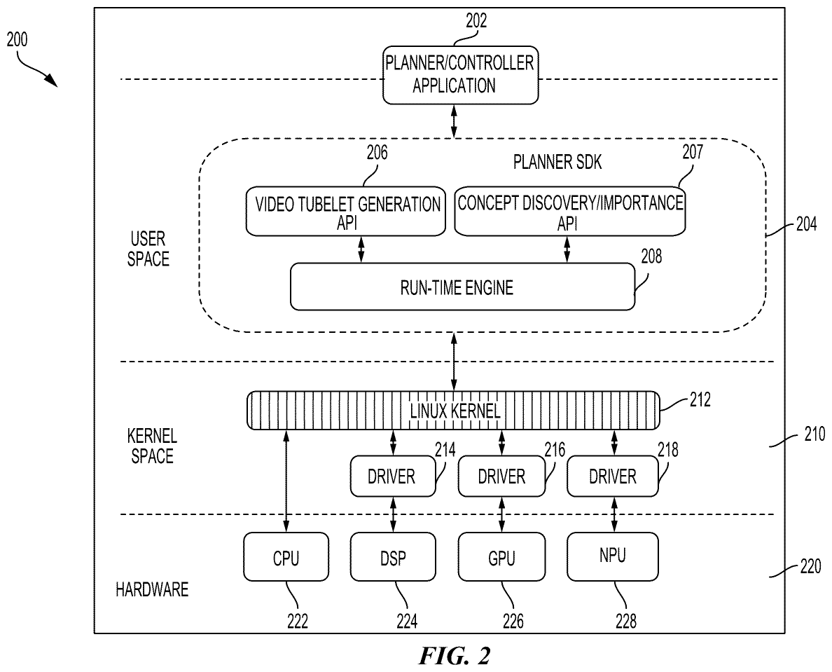

FIG. 2 is a block diagram illustrating a software architecture 200 that may modularize functions for discovering human-interpretable concepts from deep video transformer-based neural networks, according to various aspects of the present disclosure. Using the architecture, a planner/controller application 202 is designed to cause various processing blocks of a system-on-a-chip (SOC) 220 (for example a CPU 222, a DSP 224, a GPU 226, and/or an NPU 228) to perform supporting computations during run-time operation of the planner/controller application 202.

The planner/controller application 202 may be configured to call functions defined in a user space 204 that may, for example, provide for discovering human-interpretable concepts from deep video transformer-based neural networks based on video captured by a camera of an ego vehicle. The planner/controller application 202 may make a request to compile program code associated with a library defined in a video tubelet generation application programming interface (API) 206 to pass a set of videos through a video-based transformer model to select an intermediate video feature of each of the set of videos. Additionally, the video tubelet generation API 206 is configured to apply simple linear iterative clustering (SLIC) to each intermediate video feature of the set of videos to obtain corresponding tubelets to the selected intermediate video features of each of the set of videos.

The planner/controller application 202 may make a request to compile program code associated with a library defined in a concept discovery/importance API 207 to cluster the entire dataset of tubelets through convex non-negative matrix factorization to form concepts of the set of videos. Additionally, the video tubelet generation API 206 is configured to calculate the concepts' importance by simultaneously removing a set of concepts from features of the vision-based transformer model and to calculate a performance degradation from a baseline performance of the vision-based transformer model. The planner/controller application 202 may configure a vehicle control action by planning a trajectory of the ego vehicle, according to the discovered objects within a scene surrounding the ego vehicle detected from the reconstructed video frame sequences.

A run-time engine 208, which may be compiled code of a runtime framework, may be further accessible to the planner/controller application 202. The planner/controller application 202 may cause the run-time engine 208, for example, to perform tracking of moving objects in subsequent point cloud sequences of a LIDAR camera stream. When an object is detected within a predetermined distance of the ego vehicle, the run-time engine 208 may in turn send a signal to an operating system 210, such as a Linux Kernel 212, running on the SOC 220. The operating system 210, in turn, may cause a computation to be performed on the CPU 222, the DSP 224, the GPU 226, the NPU 228, or some combination thereof. The CPU 222 may be accessed directly by the operating system 210, and other processing blocks may be accessed through a driver, such as drivers 214-218 for the DSP 224, for the GPU 226, or for the NPU 228. In the illustrated example, the deep neural network may be configured to run on a combination of processing blocks, such as the CPU 222 and the GPU 226, or may be run on the NPU 228 if present.

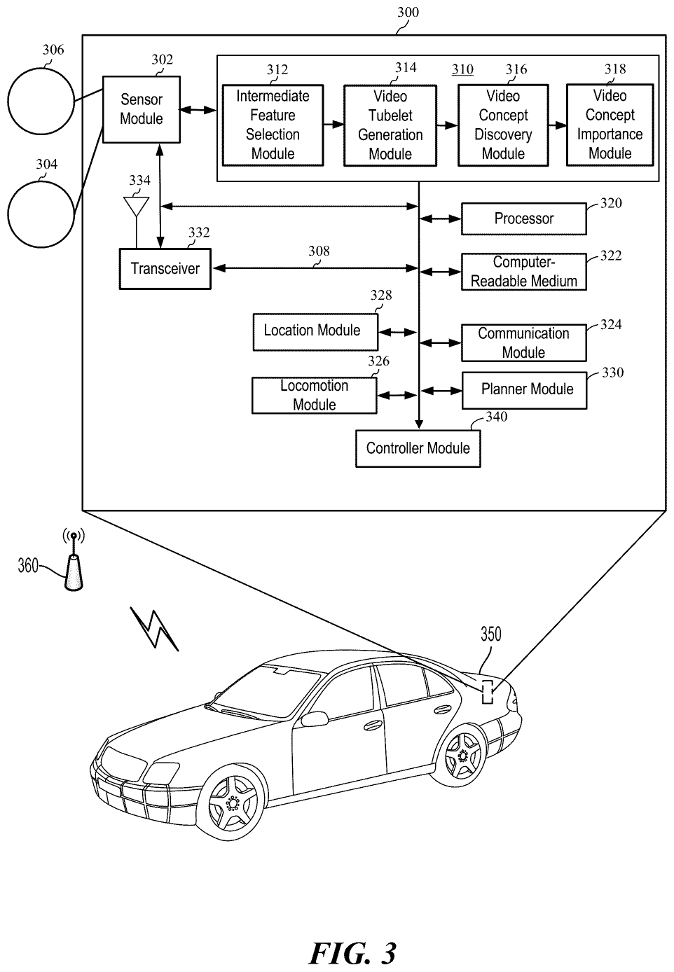

FIG. 3 is a diagram illustrating an example of a hardware implementation for a human-interpretable concept discovery system 300 for understanding a video transformer-based neural network, according to various aspects of the present disclosure. The human-interpretable concept discovery system 300 may be configured for planning and control of an ego vehicle in response to discovered objects in video frame sequences captured by a camera during operation of a car 350. The human-interpretable concept discovery system 300 may be a component of a vehicle, a robotic device, or other device. For example, as shown in FIG. 3, the human-interpretable concept discovery system 300 is a component of the car 350. Aspects of the present disclosure are not limited to the human-interpretable concept discovery system 300 being a component of the car 350, as other devices, such as a bus, motorcycle, or other like vehicle, are also contemplated for using the human-interpretable concept discovery system 300. The car 350 may be autonomous or semi-autonomous.

The human-interpretable concept discovery system 300 may be implemented with an interconnected architecture, such as a controller area network (CAN) bus, represented by an interconnect 308. The interconnect 308 may include any number of point-to-point interconnects, buses, and/or bridges depending on the specific application of the human-interpretable concept discovery system 300 and the overall design constraints of the car 350. The interconnect 308 links together various circuits including one or more processors and/or hardware modules, represented by a sensor module 302, an ego perception module 310, a processor 320, a computer-readable medium 322, communication module 324, a locomotion module 326, a location module 328, a planner module 330, and a controller module 340. The interconnect 308 may also link various other circuits such as timing sources, peripherals, voltage regulators, and power management circuits, which are well known in the art, and therefore, will not be described any further.

The human-interpretable concept discovery system 300 includes a transceiver 332 coupled to the sensor module 302, the ego perception module 310, the processor 320, the computer-readable medium 322, the communication module 324, the locomotion module 326, the location module 328, a planner module 330, and the controller module 340. The transceiver 332 is coupled to an antenna 334. The transceiver 332 communicates with various other devices over a transmission medium. For example, the transceiver 332 may receive commands via transmissions from a user or a remote device. As discussed herein, the user may be in a location that is remote from the location of the car 350. As another example, the transceiver 332 may transmit the pseudo-labeled point cloud sequences and/or planned actions from the ego perception module 310 to a server (not shown).

The human-interpretable concept discovery system 300 includes the processor 320 coupled to the computer-readable medium 322. The processor 320 performs processing, including the execution of software stored on the computer-readable medium 322 for discovering human-interpretable concepts from deep video transformer-based neural networks, according to aspects of the present disclosure. The software, when executed by the processor 320, causes the human-interpretable concept discovery system 300 to perform the various functions described for ego vehicle perception based on concept discovery from video frame sequences captured by a camera of an ego vehicle, such as the car 350, or any of the modules (e.g., 302, 310, 324, 326, 328, 330, and/or 340). The computer-readable medium 322 may also be used for storing data that is manipulated by the processor 320 when executing the software.

The sensor module 302 may obtain images via different sensors, such as a first sensor 304 and a second sensor 306. The first sensor 304 may be a vision sensor (e.g., a stereoscopic camera or a red-green-blue (RGB) camera) for capturing 2D RGB images. The second sensor 306 may be a ranging sensor, such as a light detection and ranging (LIDAR) sensor or a radio detection and ranging (RADAR) sensor. Of course, aspects of the present disclosure are not limited to the sensors, as other types of sensors (e.g., thermal, sonar, and/or lasers) are also contemplated for either of the first sensor 304 or the second sensor 306.

The images of the first sensor 304 and/or the second sensor 306 may be processed by the processor 320, the sensor module 302, the ego perception module 310, the communication module 324, the locomotion module 326, the location module 328, and the controller module 340. In conjunction with the computer-readable medium 322, the images from the first sensor 304 and/or the second sensor 306 are processed to implement the functionality described herein. In one configuration, detected 3D object information captured by the first sensor 304 and/or the second sensor 306 may be transmitted via the transceiver 332. The first sensor 304 and the second sensor 306 may be coupled to the car 350 or may be in communication with the car 350.

The location module 328 may determine a location of the car 350. For example, the location module 328 may use a global positioning system (GPS) to determine the location of the car 350. The location module 328 may implement a dedicated short-range communication (DSRC)-compliant GPS unit. A DSRC-compliant GPS unit includes hardware and software to make the car 350 and/or the location module 328 compliant with one or more of the following DSRC standards, including any derivative or fork thereof: EN 12253:2004 Dedicated Short-Range Communication—Physical layer using microwave at 5.9 GHZ (review); EN 12795:2002 Dedicated Short-Range Communication (DSRC)—DSRC Data link layer: Medium Access and Logical Link Control (review); EN 12834:2002 Dedicated Short-Range Communication—Application layer (review); EN 13372:2004 Dedicated Short-Range Communication (DSRC)—DSRC profiles for RTTT applications (review); and EN ISO 14906:2004 Electronic Fee Collection—Application interface.

A DSRC-compliant GPS unit within the location module 328 is operable to provide GPS data describing the location of the car 350 with space-level accuracy for accurately directing the car 350 to a desired location. For example, the car 350 is driving to a predetermined location and desires partial sensor data. Space-level accuracy means the location of the car 350 is described by the GPS data sufficient to confirm a location of the parking space of the car 350. That is, the location of the car 350 is accurately determined with space-level accuracy based on the GPS data from the car 350.

The communication module 324 may facilitate communications via the transceiver 332. For example, the communication module 324 may be configured to provide communication capabilities via different wireless protocols, such as Wi-Fi, 5G new radio (NR), long term evolution (LTE), 3G, etc. The communication module 324 may also communicate with other components of the car 350 that are not modules of the human-interpretable concept discovery system 300. The transceiver 332 may be a communications channel through a network access point 360. The communications channel may include DSRC, LTE, LTE-D2D, mmWave, Wi-Fi (infrastructure mode), Wi-Fi (ad-hoc mode), visible light communication, TV white space communication, satellite communication, full-duplex wireless communications, or any other wireless communications protocol such as those mentioned herein.

In some configurations, the network access point 360 includes Bluetooth® communication networks or a cellular communications network for sending and receiving data, including via short messaging service (SMS), multimedia messaging service (MMS), hypertext transfer protocol (HTTP), direct data connection, wireless application protocol (WAP), e-mail, DSRC, full-duplex wireless communications, mmWave, Wi-Fi (infrastructure mode), Wi-Fi (ad-hoc mode), visible light communication, TV white space communication, and satellite communication. The network access point 360 may also include a mobile data network that may include third generation (3G), fourth generation (4G), fifth generation (5G) new radio (NR), sixth generation (6G), long term evolution (LTE), LTE-vehicle-to-everything (V2X), LTE-driver-to-driver (D2D), Voice over LTE (VoLTE), or any other mobile data network or combination of mobile data networks. Further, the network access point 360 may include one or more IEEE 802.11 wireless networks.

The human-interpretable concept discovery system 300 also includes the planner module 330 for planning a selected route/action (e.g., collision avoidance) of the car 350 and the controller module 340 to control the locomotion of the car 350. The controller module 340 may perform the selected action via the locomotion module 326 for autonomous operation of the car 350 along, for example, a selected route. In one configuration, the planner module 330 and the controller module 340 may collectively override a user input when the user input is expected (e.g., predicted) to cause a collision according to an autonomous level of the car 350. The modules may be software modules running in the processor 320, resident/stored in the computer-readable medium 322, and/or hardware modules coupled to the processor 320, or some combination thereof.

The National Highway Traffic Safety Administration (NHTSA) has defined different “levels” of autonomous vehicles (e.g., Level 0, Level 1, Level 2, Level 3, Level 4, and Level 5). For example, if an autonomous vehicle has a higher-level number than another autonomous vehicle (e.g., Level 3 is a higher-level number than Levels 2 or 1), then the autonomous vehicle with a higher-level number offers a greater combination and quantity of autonomous features relative to the vehicle with the lower-level number. These various levels of autonomous vehicles are described briefly below.
Level 0: In a Level 0 vehicle, the set of advanced driver assistance system (ADAS) features installed in a vehicle provide no vehicle control but may issue warnings to the driver of the vehicle. A vehicle which is Level 0 is not an autonomous or semi-autonomous vehicle.
Level 1: In a Level 1 vehicle, the driver is ready to take driving control of the autonomous vehicle at any time. The set of ADAS features installed in the autonomous vehicle may provide autonomous features such as: adaptive cruise control (ACC); parking assistance with automated steering; and lane keeping assistance (LKA) type II, in any combination.
Level 2: In a Level 2 vehicle, the driver is obliged to detect objects and events in the roadway environment and respond if the set of ADAS features installed in the autonomous vehicle fail to respond properly (based on the driver's subjective judgement). The set of ADAS features installed in the autonomous vehicle may include accelerating, braking, and steering. In a Level 2 vehicle, the set of ADAS features installed in the autonomous vehicle can deactivate immediately upon takeover by the driver.
Level 3: In a Level 3 ADAS vehicle, within known, limited environments (such as freeways), the driver can safely turn their attention away from driving tasks but must still be prepared to take control of the autonomous vehicle when needed.
Level 4: In a Level 4 vehicle, the set of ADAS features installed in the autonomous vehicle can control the autonomous vehicle in all but a few environments, such as severe weather. The driver of the Level 4 vehicle enables the automated system (which is comprised of the set of ADAS features installed in the vehicle) only when it is safe to do so. When the automated Level 4 vehicle is enabled, driver attention is not required for the autonomous vehicle to operate safely and consistent within accepted norms.
Level 5: In a Level 5 vehicle, other than setting the destination and starting the system, no human intervention is involved. The automated system can drive to any location where it is legal to drive and make its own decision (which may vary based on the district where the vehicle is located).

A highly autonomous vehicle (HAV) is an autonomous vehicle that is Level 3 or higher. Accordingly, in some configurations the car 350 is one of the following: a Level 0 non-autonomous vehicle; a Level 1 autonomous vehicle; a Level 2 autonomous vehicle; a Level 3 autonomous vehicle; a Level 4 autonomous vehicle; a Level 5 autonomous vehicle; and an HAV.

The ego perception module 310 may be in communication with the sensor module 302, the processor 320, the computer-readable medium 322, the communication module 324, the locomotion module 326, the location module 328, the planner module 330, the transceiver 332, and the controller module 340. In one configuration, the ego perception module 310 receives sensor data from the sensor module 302. The sensor module 302 may receive the sensor data from the first sensor 304 and the second sensor 306. According to aspects of the present disclosure, the ego perception module 310 may receive sensor data directly from the first sensor 304 or the second sensor 306 to perform monocular ego-motion estimation from images captured by the first sensor 304 or the second sensor 306 of the car 350.

Autonomous agents, such as the car 350, rely on computer vision using a trained convolutional neural network (CNN) to identify objects within areas of interest in an image of a surrounding scene of the autonomous agent. A major challenge currently faced by the automotive industry is the development of video understanding modules for vision-based applications such as the trained CNN. Various tasks are still challenging for state-of-the-art neural networks. For example, tracking objects during transformations (e.g., cutting, folding) or occlusions often causes models to produce poor outputs. Unfortunately, the concepts used by successful or unsuccessful predictions are not well understood.

Acquiring the capability to discover these concepts would allow for improved design of these models, datasets, and tasks to solve such problems. Furthermore, if these models are deployed, it is important for the automotive industry to determine failure modes and biases of the models, from both legal and application perspectives. Identifying failure modes improve processes internally as well as protecting against unwanted damages and legal challenges presented by real-world deployment of these systems. A technique for compositional feature representation for video understanding may rely on concept discovery.

As described, concept discovery is the task of identifying human-interpretable concepts in deep neural networks. While conventional algorithms may attempt to discover concepts in deep neural networks, these conventional algorithms do not work with (i) video understanding models or (ii) based on transformer architectures. Simply applying these conventional algorithms to video transformer models would fail due to the computational complexity of video tensors compared with images, and because the manipulation of tensors in a transformer produces significantly different effects on the output of the model than a convolutional neural network. To overcome these challenges, various aspects of the present disclosure leverage two unique clustering algorithms to efficiently compute concept vectors for a transformer and identify the specific features that enable the calculation of concept importance.

As shown in FIG. 3, the ego perception module 310 includes an intermediate feature selection module 312, a video tubelet generation module 314, a video concept discovery module 316, and a video concept importance module 318. The intermediate feature selection module 312, the video tubelet generation module 314, the video concept discovery module 316, and the video concept importance module 318 may be components of a same or different artificial neural network. For example, the artificial neural network is a convolutional neural network (CNN) communicably coupled to a camera of the car 350. The ego perception module 310 receives video frame sequences from the first sensor 304 and/or the second sensor 306. In one configuration, the first sensor 304 and the second sensor 306 are configured as a red-green-blue (RGB) camera sensor.

The ego perception module 310 is configured to perform self-supervised compositional feature representation for video understanding, according to aspects of the present disclosure. In this aspect of the present disclosure, the intermediate feature selection module 312 is configured to pass a set of videos (e.g., captured by the first sensor 304 and/or the second sensor 306) through a video-based transformer model to select an intermediate video feature of each of the set of videos. In response, the video tubelet generation module 314 is configured to apply simple linear iterative clustering (SLIC) to each intermediate video feature of the set of videos to obtain corresponding tubelets to the selected intermediate video features of each of the set of videos. Next, the video concept discovery module 316 is configured to cluster the entire dataset of tubelets through convex non-negative matrix factorization to form concepts of the set of videos.

Various aspects of the present disclosure are directed to a technique for compositional feature representation for video understanding that relies on concept discovery. As described, concept discovery is the task of identifying human-interpretable concepts in deep neural networks. Based on the concepts discovered from the set of videos, the video concept importance module 318 is configured to calculate the concepts' importance by simultaneously removing a set of concepts from features of the vision-based transformer model and calculating a performance degradation from a baseline performance of the vision-based transformer model.

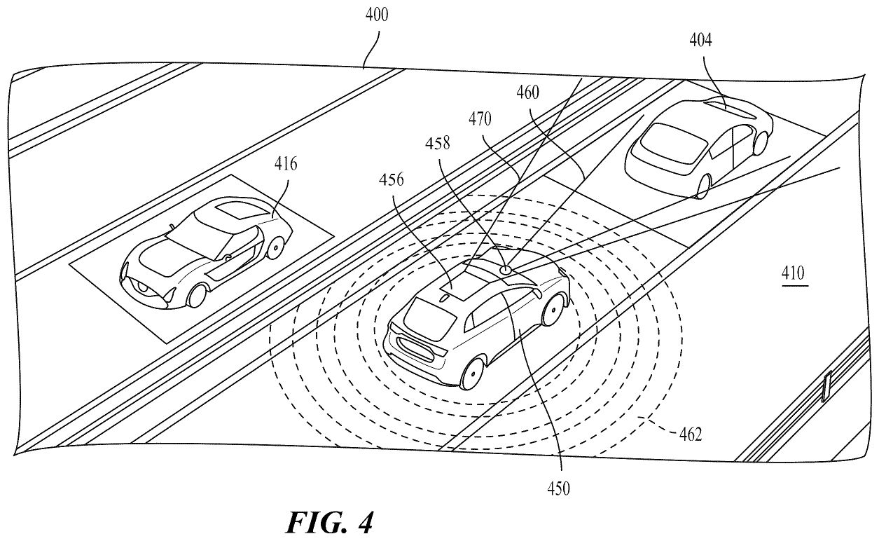

In various aspects of the present disclosure, a noise-robust process is provided by the video concept importance module 318 for ranking the concept importance to the output of a model, allowing the analysis of the model's decision-making process. Performing this analysis jointly over a diverse set of supervised and self-supervised models provides several important discoveries about universal units of video representations. The human-interpretable concept discovery system 300 may improve planning and control of an ego vehicle based on detected objects according to discovered objects from concept discovery of video frame sequences captured by an RGB camera sensor during operation of an ego vehicle, for example, as shown in FIG. 4.

FIG. 4 illustrates an example of an ego vehicle 450 (e.g., the car 350) in an environment 400, according to aspects of the present disclosure. As shown in FIG. 4, the ego vehicle 450 is traveling on a road 410. A first vehicle 404 (e.g., other agent) may be ahead of the ego vehicle 450, and a second vehicle 416 may be adjacent to the ego vehicle 450. In this example, the ego vehicle 450 may include a 2D camera 456, such as a 2D red-green-blue (RGB) camera, and a light detection and ranging (LIDAR) camera 458. Alternatively, the LIDAR camera 458 may be another RGB camera or another type of sensor, such as ultrasound, and/or a radio detection and ranging (RADAR) sensor, as shown by reference number 462. Additionally, or alternatively, the ego vehicle 450 may include one or more additional sensors. For example, the additional sensors may be side facing and/or rear facing sensors.

In one configuration, the 2D camera 456 captures a 2D image that includes objects in the field of view 460 of the 2D camera 456. The 2D camera 456 may generate unlabeled video frame sequences. The unlabeled video frame sequences captured by the 2D camera 456 may include a 2D RGB video frame of the first vehicle 404, as the first vehicle 404 is in the field of view 460 of the 2D camera 456. A field of view 470 of the LIDAR camera 458 is also shown.

The information obtained from the 2D camera 456 and the LIDAR camera 458 may be used to navigate the ego vehicle 450 along a route when the ego vehicle 450 is in an autonomous mode. The 2D camera 456 and the LIDAR camera 458 may be powered from electricity provided from the battery (not shown) of the ego vehicle 450. The battery may also power the motor of the ego vehicle 450. The information obtained from the 2D camera 456 may be used to discover an object using self-supervised motion-based learning to separate moving objects from static objects in the captured video frame sequences.

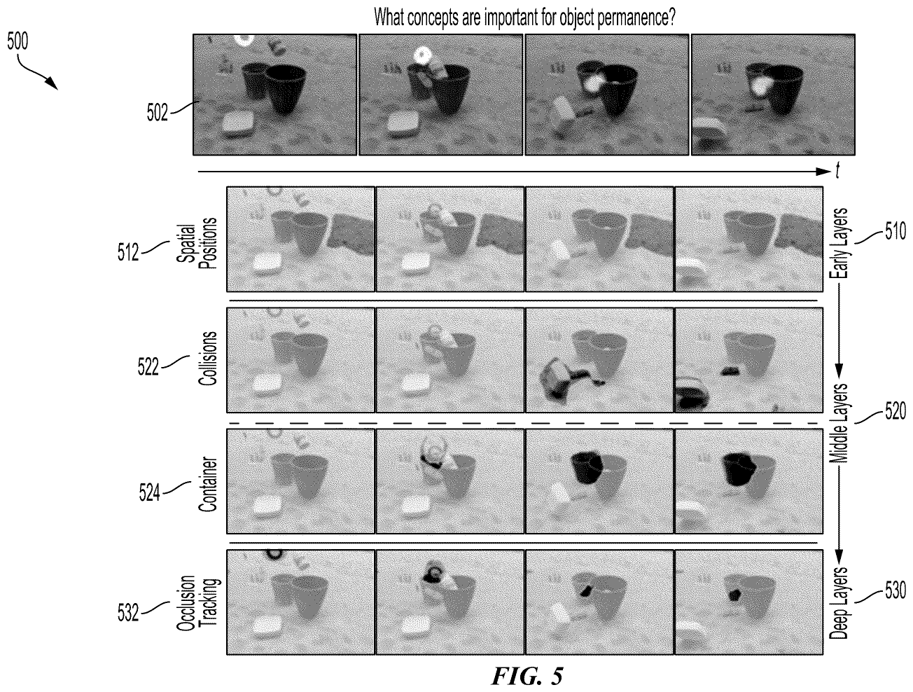

The ego vehicle 450, using the 2D camera 456, can readily collect video frame sequences while traveling on the road 410. Some aspects of the present disclosure are directed to compositional feature representation for video understanding that relies on concept discovery. As described, concept discovery is the task of identifying human-interpretable concepts in deep neural networks from video captured by the 2D camera 456 of the ego vehicle 450. These aspects of the present disclosure provide a video transformer concept discovery (VTCD) process. Beneficially, the VTCD process provides an efficient approach for unsupervised identification of units of video transformer representations/concepts. These aspects of the present disclosure learn human-interpretable concepts using a self-supervised compositional feature representation for video understanding, for example, as shown in FIG. 5.

Aspects of the present disclosure are directed to a process for discovering human-interpretable concepts from deep video transformer-based neural networks that work with (i) video understanding models or (ii) based on transformer architectures. A general process for discovering human-interpretable concepts from deep video transformer-based neural networks is introduced for discovering concepts in video-based transformers, as shown in FIG. 5.

### 1. Introduction

FIG. 5 is a combined drawing 500 illustrating heatmap predictions of an occluded object tracking method, together with a sample of concepts discovered by a video transformer concept discovery (VTCD) algorithm, according to various aspects of the present disclosure. As shown in FIG. 5, a model of the occluded object tracking method encodes positional information 512 in early layers 510 of the model, identifies containers 524 and collision events 522 in mid-layers 520 of the model, and tracks through occlusions 532 in deep layers 530 of the model. FIG. 5 illustrates a single video 502, but the discovered concepts are shared between many videos in a dataset. As described in further detail below, tracking occluded objects in a set of videos may be based on an importance of each of the concepts of the set of videos.

Understanding the hidden representations within neural networks is essential for addressing regulatory concerns, preventing harms during deployment, and can aid in the development of innovative model designs. This problem has been studied extensively in the image world, both for convolutional neural networks (CNNs) and, more recently, for transformers, resulting in several key insights. For example, during operation, image classification models extract low-level positional and texture cues at early layers and gradually combine them into higher-level, semantic concepts at later layers.

Unfortunately, while video transformers do share their overall architecture with image-level vision transformers, the insights obtained in existing works do extraordinarily little to explain their inner mechanisms. Consider, for example, the occluded object tracking method shown in FIG. 5. To accurately reason about the trajectory of the invisible object inside the pot, texture or semantic cues alone would not suffice. What, then, are the spatiotemporal mechanisms used by this approach? And are any of these mechanisms universal across video models trained for different tasks?

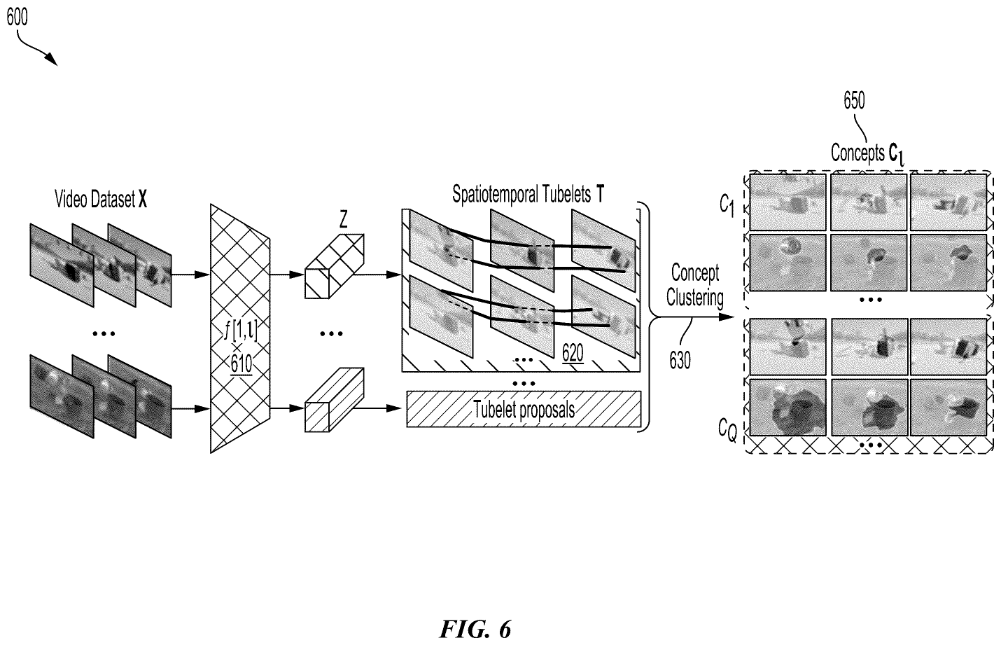

To answer these questions, various aspects of the present disclosure propose a video transformer concept discovery (VTCD) process, which provides a first concept-discovery methodology for interpreting the representations of deep video transformers. These aspects of the present disclosure focus on concept-based interpretability due to its capacity to explain the decision-making process of a complex model's distributed representations in high-level, intuitive terms. Various aspects of the present disclosure are directed to the goal of decomposing a representation at any given layer into human-interpretable ‘concepts’ without any labelled data (e.g., concept discovery) and then ranking the ‘concepts’ in terms of their importance to the model output, for example, as shown in FIG. 6.

FIG. 6 is a block diagram illustrating a video transformer concept discovery (VTCD) process 600 for understanding video transformers through universal concept discovery, according to various aspects of the present disclosure. As shown in FIG. 6, the VTCD process 600 takes a dataset of videos, X, as input and passes them to a model, ƒ_{[1,l]} 610. The set of video features, Z, are then parsed into spatiotemporal tubelet proposals, T 620, via simple linear iterative clustering (SLIC) in the feature space. Finally, a concept clustering process 630 is applied to the spatiotemporal tubelet proposals, T 620, to perform clustering across the dataset of videos, X, to discover high-level units of network representation/concepts, C 650.

As shown in FIG. 6, the VTCD process 600 first groups model features at a given layer into the spatiotemporal tubelets T 620 using SLIC, which serves as a basis for the analysis described below (see Section 2.1.1). Next, the VTCD process 600 clusters the tubelets T 620 across the dataset of videos, X, to discover high-level concepts (see Section 2.1.2) using, for example, convex non-negative matrix factorization (CNMF). For example, the resulting concepts for the occluded object tracking method are shown in FIG. 5 (bottom) and span a broad range of cues, including spatiotemporal ones that detect events, like the collision events 522, or track the containers 524.

To better understand the decision-making mechanisms of video transformers, the VTCD process 600 then quantifies the importance of the concepts 650 for the model's predictions. These aspects of the VTCD process 600 propose a novel, noise-robust approach to estimate concept importance (see Section 2.2). Unlike existing techniques that rely on gradients, or concept occlusion, the VTCD process 600 approach effectively manages redundancy in self-attention heads in transformer architectures, according to various aspects of the present disclosure.

Next, the VTCD process 600 is used to study whether there are any universal mechanisms in video transformer models that emerge irrespective of their training objective. To this end, the VTCD process 600 automatically identifies important concepts that are shared between several models in Section 3. Additionally, a diverse set of representations (e.g., supervised, self-supervised, or video-language) are then analyzed to make a number of discoveries: (i) many concepts are indeed shared between models trained for different tasks; (ii) early layers tend to form a spatiotemporal basis that underlines the rest of the information processing; and (iii) later layers form object-centric video representations even in models trained in a self-supervised way.

Finally, the VTCD process 600 can be used in an application setting to turn a pre-trained video transformer into an efficient and effective fine-grained recognition model by pruning units that are not important for the end task. For example, removing 33% of the heads from an action classification model can result in a 4.3% increase in accuracy while reducing computation from 181 to 122 GFLOPS.

Various aspects of the present disclosure are directed to the VTCD process 600 shown in FIG. 6, which provides a first concept discovery algorithm for video transformers, together with a novel method to quantify concept importance (e.g., concept randomized importance sampling (CRIS)). These aspects of the present disclosure analyze the reasoning mechanisms that are shared between multiple models by mining for universal concepts and make several important discoveries. Additionally, the VTCD process 600 can be used to improve inference time and performance for fine-grained video classification via concept pruning.

### 2. Video Transformer Concept Discovery

Various aspects of the present disclosure study the problem of decomposing a video representation into a set of high-level open-world concepts and ranking their importance for the model's predictions. For example, as shown in FIG. 6, the VTCD process 600 is given a set of red-green-blue (RGB) videos, X∈ [symbol] ^{N×3×T×H×W}, where N, T, H, and W denote the dataset size, time, height, and width, respectively, and an L layer pretrained model ƒ. Let ƒ_{[r,l]} denote the model 610 from layer r to l, with ƒ_{[1,l]}(X)=Zₗ∈ [symbol] ^{N×C×T′×H′×W′} being the intermediate representation at layer l. To decompose Zₗ into a set of human-interpretable concepts, Cₗ={c₁, . . . , c_{q}}, the N feature maps are first parsed into a set of M proposals, T∈ [symbol] ^{M×C}(M>N), where each Tₘ corresponds to a region of the input image. These proposals are then clustered into Q<<M concepts in the feature space of the model to form an assignment matrix W∈ [symbol] ^{M×Q}. Finally, the importance of each concept cᵢ to the model's prediction is quantified by a score sᵢ∈[0,1]. Performing this analysis over all the layers in ƒ produces the complete set of concepts 650 for a model, C={C₁, . . . , C_{L}}, together with their corresponding importance scores.

Unfortunately, existing approaches are not immediately applicable to video transformers because they do not scale well and are focused on 2D CNN architectures. By contrast, various aspects of the present disclosure extend concept-based interpretability to video representations. To this end, various aspects of the present disclosure first describe a computationally tractable proposal generation method (see Section 2.1.1) that operates over space-time feature volumes and outputs spatiotemporal tubelets. Next (in Section 2.1.2), existing concept clustering techniques are adapted to video transformer representations. Finally, in Section 2.2 a concept randomized importance sampling (CRIS) process is proposed, which refers to a novel concept importance estimation approach applicable to any architecture units, including transformer heads.

### 2.1. Concept Discovery

### 2.1.1 Tubelet Proposals

Conventional methods use superpixels or crops in RGB space to propose segments; however, the number of segments is exponentially greater for videos.

Moreover, proposals in color space are unrestricted and may not align with a model's encoded information, leading to many irrelevant or noisy segments. To address these drawbacks, various aspects of the present disclosure instantiate proposals in feature space, which naturally partitions a video based on the semantic information within each layer, as shown in FIG. 6, left.

More specifically, various aspects of the present disclosure construct tubelets per video via simple linear iterative clustering (SLIC) on the spatiotemporal features via

$$T = G A P ( B ⊙ Z ) = G A P ( SLIC ( Z ) ⊙ Z ) , \qquad ( 1 )$$

where T∈ [symbol] ^{M×C} is the set of tubelets for the dataset, B∈{0,1}^{C×M×N×T′×H′×W′} are spatiotemporal binary support masks obtained from the SLIC clustering, M is the total number of tubelets for all N videos (M>>N), and GAP is a global average pooling operation over the space and time dimensions.

SLIC is an extension of the K-Means algorithm that controls a trade-off between cluster support regularity and adaptability and constrains cluster support masks to be connected. Together these properties produce non-disjoint tubelets that are easier to interpret for humans because they reduce the need to address multiple regions in a video at a time. Further, the pruning step in SLIC makes it more robust to the hyperparameter denoting the number of clusters to be detected as it automatically prunes spurious, disconnected tubelets. Next, an approach is described for grouping individual tubelets into higher-level concept clusters.

### 2.1.2 Concept Clustering

A non-negative matrix factorization (NMF) process may be used to cluster proposals into concepts. For example, given a non-negative data matrix, T⁺∈ [symbol] ^{M×C}, NMF aims to find two non-negative matrices, W⁺∈ [symbol] ^{M×Q} and C⁺∈ [symbol] ^{Q×C}, such that T⁺=W⁺C⁺, where W⁺ is the cluster assignment matrix. Unfortunately, NMF cannot be applied to transformers as they do not use ReLU non-linearities, but rather GeLU non-linearities, resulting in negative activations.

Various aspects of the present disclosure solve this problem by leveraging a convex non-negative matrix factorization (CNMF) process. Despite the name, the CNMF is an extension of the NMF process that allows for negative input values. This is achieved by constraining the factorization such that the columns of W are convex combinations of the columns of T. For example, each column of W is a weighted average of the columns of T. This constraint can be written as

W=TG, (2)
where G∈[0,1]^{C×Q} and ΣⱼG_{i,j}=1. To cluster a set of tubelets, T, into corresponding concepts, the following equation is optimized:

$$( {G}^{*} , {C}^{*} ) = \begin{matrix}arg min {‖ T - TGC ‖}^{2} , \\ C > 0 , G > 0\end{matrix} \qquad ( 3 )$$

where the final set of concepts are represented by the rows of the matrix C, i.e., concept centroid cᵢ is the i^{th} row of C 650, as shown in FIG. 6.

### 2.2. Concept Importance

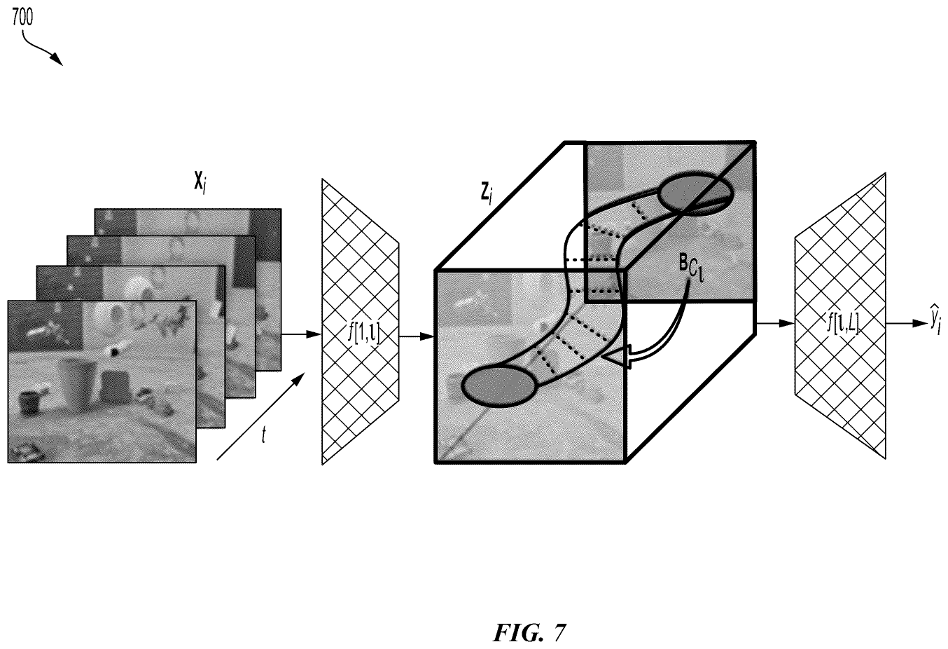

FIG. 7 is a block diagram illustrating a visual representation of concept masking for a single concept, according to various aspects of the of the present disclosure. Given a video xᵢ and a concept, cₗ, we mask the tokens of the intermediate representation zᵢ=ƒ_{[1,l]}(xᵢ) with the concepts' binary support masks, B_{cl}, to obtain the perturbed prediction, ŷᵢ.

Given a set of discovered concepts, these aspects of the present disclosure now aim to quantify their impact on model performance. For example, FIG. 7 illustrates one approach that masks out each concept independently and ranks the importance based on the drop in performance. Formally, let cₗ be a single target concept, and let B_{c}_{ₗ}∈{0,1}^{C×M×N×T′×H′×W′} be the corresponding binary support masks over X. It can then be masked in layer l via

$$\hat{y} = {f}_{[ l , L ]} ( {Z}_{l} ⊙ ( 1 - {B}_{{c}_{l}} ) ) \qquad ( 4 )$$

However, while this approach works well for convolutional neural networks (CNNs), transformers are inherently robust to small perturbations within self-attention layers. Therefore, single concept masking has negligible effect on performance. Instead, a high percentage of sampled concepts is masked in parallel (across all layers and heads) and averaging the results over thousands of samples producing valid concept rankings is then empirically validated.

These aspects of the present disclosure propose a concept randomized importance sampling (CRIS) process, a robust method to compute importance for any unit of interest. To this end, the CRIS process first randomly samples K different concept sets, such that each C^{k}⊂C. In this example, Cₗ^{k} represents the set of concepts in C^{k} discovered at layer l, with B_{C}_{ₗ}_{^{k}} denoting the corresponding binary support masks. Additionally, each concept at each layer of the model is masked out as follows:

$${\hat{y}}_{k} = g ( {\tilde{B}}_{{c}_{L}^{k}} ⊙ {f}_{[ L - 1 , L ]} ( … ( {\tilde{B}}_{{C}_{1}^{k}} ⊙ {f}_{[ 0 , 1 ]} ( X ) ) ) ) , \qquad ( 5 )$$

where g(·) is the prediction head (e.g., a minimum layer perceptron (MLP)) and \tilde{B} denotes the inverse mask (i.e., 1-B). Finally, the importance of each concept, cᵢ, is calculated as follows:

$${s}_{i} = \frac{1}{K} {\sum }_{k}^{K} ( ( \tilde{y} , y ) - ( {\hat{y}}_{k} , y ) ) {{c}_{i} ∈ {C}^{k}}_{} , \qquad ( 6 )$$

where \tilde{y} is the original prediction without any masking and [symbol] is a metric quantifying performance (e.g., accuracy).

### 3. Understanding Transformers With VTCD

Referring again to FIG. 6, the VTCD process 600 facilitates the identification of concepts within any model and quantifying their significance in the model's predictions. Unfortunately, this is not enough to fully understand the computations performed by a video transformer. It is also important to understand how these concepts are employed in the model's information flow.

For example, the residual stream of a transformer serves as the backbone of the information flow to help understand how these concepts are employed in the model's information flow. For example, each self-attention block reads information from the residual stream with a linear projection, performs self-attention operations to process it, and finally writes the results back into the residual stream. In this example, self-attention processing is performed individually for each head and several studies have shown, both in vision and natural language processing (NLP), that different self-attention heads capture distinct information. In other words, heads form the basis of the transformer representation.

A closer analysis of the concepts found in the heads of the VTCD process 600 allows identification of several patterns in the information processing of that model. FIG. 5 shows that the heads in early layers 510 group input tokens based on their spatiotemporal positions (e.g., positional information 512). This information is then used to track objects and identify events in mid-layers 520, and deep layers 530 (e.g., later layers) utilize mid-layer representations to reason about occlusions. Aspects of the present disclosure analyze whether any of these mechanisms are universal across video transformers trained on different datasets with varying objectives.

### 4. Rosetta Concepts: Finding Universal Spatiotemporal Mechanisms in Transformers

Various aspects of the present disclosure propose mining for Rosetta concepts that are shared between models and represent the same information. The key to identifying Rosetta units is a robust metric, R, where a higher R value corresponds to the two units having a larger amount of shared information. Previous work focused on finding Rosetta neurons in image models based on correlating neurons' activation maps. Conversely, aspects of the present disclosure propose measuring the similarity between concepts (e.g., distributed representations) via the mean Intersection over Union (mIoU) of the concepts' support.

In particular, Rosetta concepts are mined by first applying VTCD to a set of D models {ƒ¹, . . . , ƒ^{D}}, resulting in discovered concepts, C^{d}={c₁^{d}, . . . , cᵢ^{d}}, and importance scores, S^{d}={s₁^{d}, . . . , sᵢ^{d}}, for each model ƒ^{d}. This process then aims to measure the similarity between all concept d-tuples between the models. More specifically, given the binary support masks for all analyzed videos, Bᵢ^{d}, the similarity via the intersection-over-union (IoU) metric to produce the Rosetta score, R, of a concept set, is compared as

$$R ( {c}_{i}^{1} , … , {c}_{j}^{D} ) = \frac{\vert {B}_{i}^{1} ⋂ … ⋂ {B}_{j}^{D} \vert}{\vert {B}_{i}^{1} ⋃ … ⋃ {B}_{j}^{D} \vert} . \qquad ( 7 )$$

Before computing R, each models' concepts are filtered by their importance scores and only consider the most important ϵ% for each model. This simultaneously produces Rosetta concepts that are more meaningful to all models and exponentially reduces the number of comparisons.

As some concepts may reside in a subset of the models but are still interesting to analyze, the number of models considered in the Rosetta score is varied, 1<d<D. For example, let R^{d} be the set of all Rosetta scores with 2 concepts. The final list of Rosetta concepts is those corresponding to the scores, R, which are above a threshold, δ, for example,

$$R = \{ R \vert R > δ ∀ R ∈ {R}^{d} , d = 2 , … , D \} . \qquad ( 8 )$$

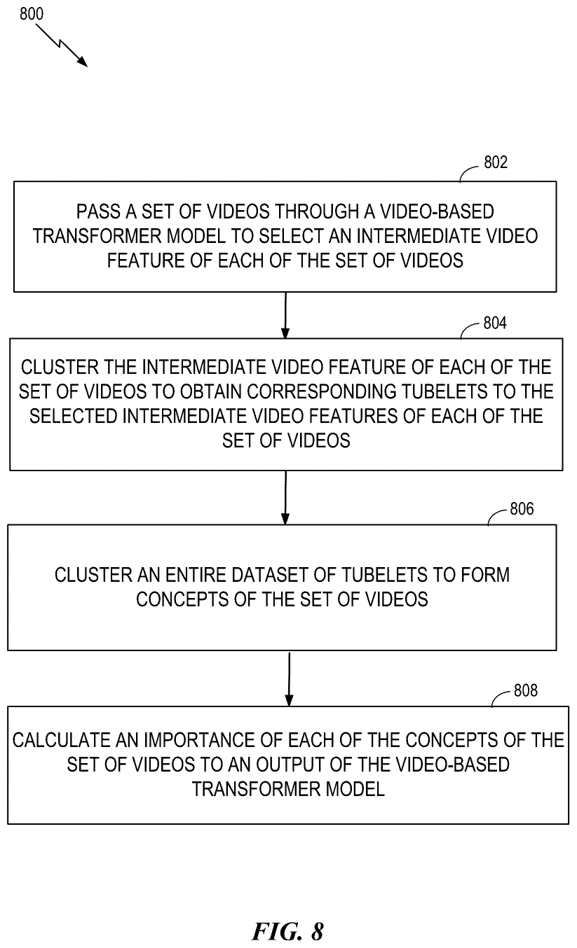

Various aspects of the present disclosure introduce a video transformer concept discovery (VTCD) algorithm process for concept discovery in video transformers. The aspects of the present disclosure extract human-interpretable concepts from a variety of video understanding models and quantifying their importance for the models' predictions. These aspects of the present disclosure utilize the VTCD process to discover concepts that are shared between several models trained with varying objectives, including self-supervised and video-language models. These aspects of the present disclosure reveal common information processing patterns among these models, such as the existence of a spatiotemporal basis in early layers and the emergence of object-centric representation in later layers. Additionally, the VTCD process can be used to improve efficiency and performance of fine-grained recognition models by implementing training protocols, including model pruning for improved performance and efficient action recognition, and model debugging. Additionally, the VTCD process can be used for determining training protocols that produce models with desired concepts to provide downstream applications. A process of discovering human-interpretable concepts from a deep video transformer-based neural network is further described in FIG. 8.

FIG. 8 is a flowchart illustrating a method for discovering human-interpretable concepts from video-based transformer models, according to aspects of the present disclosure. A method 800 begin at block 802, in which a set of videos is passed through a video-based transformer model to select an intermediate video feature of each of the set of videos. For example, as shown in FIG. 3, the ego perception module 310 is configured to perform self-supervised compositional feature representation for video understanding, according to aspects of the present disclosure. In this aspect of the present disclosure, the intermediate feature selection module 312 is configured to pass a set of videos (e.g., captured by the first sensor 304 and/or the second sensor 306) through a video-based transformer model to select an intermediate video feature of each of the set of videos.

At block 804, the intermediate video feature of each of the set of videos are clustered to obtain corresponding tubelets to the selected intermediate video features of each of the set of videos. For example, as shown in FIG. 3, the video tubelet generation module 314 is configured to apply simple linear iterative clustering (SLIC) to each intermediate video feature of the set of videos to obtain corresponding tubelets to the selected intermediate video features of each of the set of videos.

At block 806, an entire dataset of tubelets is clustered to form concepts of the set of videos. For example, as shown in FIG. 3, the video concept discovery module 316 is configured to cluster the entire dataset of tubelets through convex non-negative matrix factorization to form concepts of the set of videos. For example, as shown in FIG. 6, the VTCD process 600 clusters the tubelets T 620 across the dataset of videos, X, to discover high-level concepts using, for example, convex non-negative matrix factorization (CNMF).

At block 808, an importance of each of the concepts of the set of videos is calculated to an output of the video-based transformer model. For example, as shown in FIG. 3, a noise-robust process is provided by the video concept importance module 318 for ranking the concept importance to the output of a model, allowing the analysis of the model's decision-making process. Performing this analysis jointly over a diverse set of supervised and self-supervised models provides several important discoveries about universal units of video representations.

A video tensor has four dimensions, [channels, time, width, height]. Exploring the entire space of subsets (e.g., tubelets) of a tensor with four dimensions is computationally intractable. Therefore, an intelligent method of creating a computationally feasible set of semantically meaningful tubelets is proposed. Conventional solutions operate using RGB super-pixel segmentation, or random rectangular crops. RGB super-pixels have no relation to a model's feature space (e.g., the space for which interpretation is desired) and, as mentioned before, taking random crops of a video tensor is computationally infeasible to perform the substantial amount of generated (e.g., 10,000's of tubelets) will be generated. Various aspects of the present disclosure overcome this issue by applying a location-sensitive clustering technique (e.g., simple linear iterative clustering (SLIC)) in the model's feature space to propose a moderate amount (e.g., ˜5-15) of tubelets that are then used for a concept clustering stage.

In some aspects of the present disclosure, the method 800 may be performed by the system-on-a-chip (SOC) 100 (FIG. 1) or the software architecture 200 (FIG. 2) of the ego vehicle 150 (FIG. 1). That is, each of the elements of the method 800 may, for example, but without limitation, be performed by the SOC 100, the software architecture 200, or the processor (e.g., CPU 102) and/or other components included therein of the ego vehicle 150.

The various operations of methods described above may be performed by any suitable means capable of performing the corresponding functions. The means may include various hardware and/or software component(s) and/or module(s), including, but not limited to, a circuit, an application-specific integrated circuit (ASIC), or processor. Where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Additionally, “determining” may include receiving (e.g., receiving information), accessing (e.g., accessing data in a memory), and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules, and circuits described in connection with the present disclosure may be implemented or performed with a processor configured according to the present disclosure, a digital signal processor (DSP), an application-specific integrated circuit (ASIC), a field-programmable gate array signal (FPGA) or other programmable logic device (PLD), discrete gate or transistor logic, discrete hardware components, or any combination thereof designed to perform the functions described herein. The processor may be a microprocessor, but, in the alternative, the processor may be any commercially available processor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media may include random access memory (RAM), read-only memory (ROM), flash memory, erasable programmable read-only memory (EPROM), electrically erasable programmable read-only memory (EEPROM), registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may connect a network adapter, among other things, to the processing system via the bus. The network adapter may implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Examples of processors that may be specially configured according to the present disclosure include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read-only memory (ROM), programmable read-only memory (PROM), erasable programmable read-only memory (EPROM), electrically erasable programmable read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such with cache and/or specialized register files. Although the various components discussed may be described as having a specific location, such as a local component, they may also be configured in numerous ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application-specific integrated circuit (ASIC) with the processor, the bus interface, the user interface, supporting circuitry, and at least a portion of the machine-readable media integrated into a single chip, or with one or more field-programmable gate arrays (FPGAs), programmable logic devices (PLDs), controllers, state machines, gated logic, discrete hardware components, or any other suitable circuitry, or any combination of circuits that can perform the various functions described throughout the present disclosure. Those skilled in the art will recognize how best to implement the described functionality for the processing system depending on the application and the overall design constraints imposed on the overall system.

The machine-readable media may comprise several software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a non-transitory computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can carry or store desired program code in the form of instructions or data structures and that can be accessed by a computer. Additionally, any connection is properly termed a computer- readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc; where disks usually reproduce data magnetically, while discs reproduce data optically with lasers. Thus, in some aspects computer-readable media may comprise non-transitory computer-readable media (e.g., tangible media). In addition, for other aspects, computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for discovering human-interpretable concepts from video-based transformer models, comprising:
passing a set of videos through a video-based transformer model to select an intermediate video feature of each of the set of videos;
clustering the intermediate video feature of each of the set of videos to obtain corresponding tubelets to the selected intermediate video features of each of the set of videos;
clustering an entire dataset of tubelets to form concepts of the set of videos; and
calculating an importance of each of the concepts of the set of videos to an output of the video-based transformer model.

2. The method of claim 1, further comprising determining training protocols that produce models with desired concepts to provide downstream applications.

3. The method of claim 2, in which the training protocols comprise model pruning for improved performance and efficient action recognition, and model debugging.

4. The method of claim 1, in which clustering the intermediate video feature of each of the set of videos comprises applying simple linear iterative clustering (SLIC) to the intermediate video feature of each of the set of videos to obtain the corresponding tubelets to the selected intermediate video features of each of the set of videos.

5. The method of claim 1, in which clustering the entire dataset of tubelets comprises clustering the entire dataset of tubelets through convex non-negative matrix factorization to form the concepts of the set of videos.

6. The method of claim 1, in which calculating the importance comprises:
simultaneously removing a set of the concepts from features of the video-based transformer model; and
calculating a performance degradation of the video-based transformer model from a baseline performance of the video-based transformer model.

7. The method of claim 6, further comprising displaying the set of the concepts associated with an increase of the performance degradation as human-interpretable concepts of the video-based transformer model.

8. The method of claim 1, further comprises tracking occluded objects in the set of videos based on the importance of each of the concepts of the set of videos.

9. A non-transitory computer-readable medium having program code recorded thereon for discovering human-interpretable concepts from video-based transformer models, the program code being executed by a processor and comprising:
program code to pass a set of videos through a video-based transformer model to select an intermediate video feature of each of the set of videos;
program code to cluster the intermediate video feature of each of the set of videos to obtain corresponding tubelets to the selected intermediate video features of each of the set of videos;
program code to cluster an entire dataset of tubelets to form concepts of the set of videos; and
program code to calculate an importance of each of the concepts of the set of videos to an output of the video-based transformer model.

10. The non-transitory computer-readable medium of claim 9, further comprising program code to determine training protocols that produce models with desired concepts to provide downstream applications.

11. The non-transitory computer-readable medium of claim 10, in which the training protocols comprise model pruning for improved performance and efficient action recognition, and model debugging.

12. The non-transitory computer-readable medium of claim 9, in which the program code to cluster the intermediate video feature of each of the set of videos comprises program code to apply simple linear iterative clustering (SLIC) to the intermediate video feature of each of the set of videos to obtain the corresponding tubelets to the selected intermediate video features of each of the set of videos.

13. The non-transitory computer-readable medium of claim 9, in which the program code to cluster the entire dataset of tubelets comprises program code to cluster the entire dataset of tubelets through convex non-negative matrix factorization to form the concepts of the set of videos.

14. The non-transitory computer-readable medium of claim 9, in which the program code to calculate the importance comprises:
program code to simultaneously remove a set of the concepts from features of the video-based transformer model; and
program code to calculate a performance degradation of the video-based transformer model from a baseline performance of the video-based transformer model.

15. The non-transitory computer-readable medium of claim 14, further comprising program code to display the set of the concepts associated with an increase of the performance degradation as human-interpretable concepts of the video-based transformer model.

16. The non-transitory computer-readable medium of claim 9, further comprises program code to tracking occluded objects in the set of videos based on the importance of each of the concepts of the set of videos.

17. A system for discovering human-interpretable concepts from video-based transformer models, the system comprising:
an intermediate feature selection module to pass a set of videos through a video-based transformer model to select an intermediate video feature of each of the set of videos;
a video tubelet generation module to cluster the intermediate video feature of each of the set of videos to obtain corresponding tubelets to the selected intermediate video features of each of the set of videos;
a video concept discovery module to cluster an entire dataset of tubelets to form concepts of the set of videos; and
a video concept importance module to calculate an importance of each of the concepts of the set of videos to an output of the video-based transformer model.

18. The system of claim 17, in which the video tubelet generation module is further to apply simple linear iterative clustering (SLIC) to the intermediate video feature of each of the set of videos to obtain the corresponding tubelets to the selected intermediate video features of each of the set of videos.

19. The system of claim 17, in which the video concept discovery module is further to cluster the entire dataset of tubelets through convex non-negative matrix factorization to form the concepts of the set of videos.

20. The system of claim 17, further comprises a sensor module to track occluded objects in the set of videos based on the importance of each of the concepts of the set of videos.
